(19) United States
(12) Patent Application Publication
(10) Pub. No.: US 2018/0330886 A1
(43) Pub. Date: Nov. 15, 2018

(54) ELECTROMECHANICAL DEVICE WITH IMPROVED CONNECTION

(71) Applicant: STRETCHSENSE LIMITED, Auckland (NZ)

(72) Inventors: Todd Alan Gisby, Auckland (NZ); Ian Scott-Woods, Auckland (NZ)

(21) Appl. No.: 15/543,568

(22) PCT Filed: Jan. 15, 2016
(86) PCT No.: PCT/NZ2016/050003

§ 371 Date: Jul. 13, 2017

(30) Foreign Application Priority Data
Jan. 15, 2015 (NZ) 703868

(51) Int. Cl. H01G 5/04; H01G 5/18; H01G 5/011; H01G 5/40; H01B 7/04

(52) U.S. Cl. CPC H01G 5/04; H01G 5/18; H01B 7/04; H01G 5/40; H01G 5/011

(57) ABSTRACT

In one aspect the invention provides an electromechanical device having a conductive component which is stretchable and having a conductive lead to connect the component to an electrical circuit. The conductive lead may be arranged as threaded through the component at multiple locations on the component layer to integrate the lead with the component. Aspects provide a laminated capacitor formed of elastic material with first and second elastic electrode layers. The conductive lead may comprises an inner conductor and an outer conductor arranged to cover the inner conductor. A length of exposed inner conductor is arranged threaded through the first component and an exposed length the outer conductor is arranged threaded through the second conductive component.

### FIELD OF THE INVENTION

This invention relates to improvements in respect of connection of stretchable electromechanical devices to electrical circuits, such as the connection of stretchable sensing capacitors to instrumenting circuits. This invention particularly relates to improvements in respect of combined electrical and mechanical connection of electromechanical devices. This invention further particularly relates to improvements in respect of combined electrical and mechanical connection of stretchable capacitors.

### BACKGROUND OF THE INVENTION

Conventional electronic circuits such as Printed Circuit Boards (PCBs) are made from rigid materials and there are many off-the shelf solutions for electrically and mechanically tethering them together either directly via a plug and socket for example, or by using a cable, or cable assembly. Flexible Printed Circuit Boards (FPCs) are effectively thin PCBs that can mechanically bend but cannot stretch. FPCs have many connector options specifically designed for them, and, because they do not stretch, are compatible with many of the existing connector and cable solutions that have been designed for conventional PCBs.

New electromechanical devices, however, can be both flexible and compliant and even stretchable and capable of returning to their original configuration. It is highly desirable to be able to connect these electromechanical devices to electrical circuits to combine them with conventional PCBs or FPCs in larger systems.

Stretchable electromechanical devices such as can be made from elastomeric materials such as silicones, polyurethanes, or acrylic polymers for example, or from other stretchable materials such as knitted fabrics for example, and can undergo large elastic deformations relative their original dimensions. These large stretches present a challenge when it comes to creating an electrical and mechanical interface with conventional PCBs or FPCs. This is particularly the case in applications involving repeated cycles of elastic deformation.

Stretchable, elastic capacitors are ideal for sensing deformation in soft bodies without significantly influencing the behavior of the soft body, especially for measuring the strains and pressures associated with human movement. For some applications it is desirable to be able to place these capacitive sensors at a different location to any associated circuitry, or to distribute sensors to specific locations around the body, for example. This raises the prospect of collecting information from one or more remote locations. One option is to do so wirelessly, with each sensor forming a node in a local area wireless network. This necessitates the inclusion of an RF transmitter and power source at each sensor, increasing part count and cost, and it becomes exponentially more difficult to collect and synchronise data from each capacitor as the number of wireless nodes increases, or limits the rate at which data can be acquired due to bandwidth sharing and potentially interference. In some applications it is desirable to have several sensors connected to a single processor node/RF transmitter to form a cluster, which in turn can be connected to other clusters via a wired or wireless connection. This reduces overall system cost by reducing part count, and facilitates easy collection, compression, and synchronisation of data from multiple sensors. If clusters are connected wirelessly, there are fewer wireless nodes, thus they can have a larger share of the available bandwidth leading to a more efficient overall network.

In order for a cluster-based configuration to be effective, however, it requires a means of connecting sensors to the central processing node. The sensors can be both flexible and compliant, and desirable processing nodes are compact and unobtrusive. It is important that the connection between them is neither bulky nor substantially restricts the movement of the soft body being measured, i.e., the connection does not negate the benefits of having a soft sensor. Furthermore it is critical that the sensor signal is partially or completely shielded from external sources of electromagnetic noise to prevent corruption of the signal between the sensor and the processing node. Shielding the connection, however, naturally creates a parasitic capacitance between the signal line and the shield. This capacitance can add to the capacitance of the sensor, thus it is important to be able to account for this parasitic capacitance and distinguish it from the sensor capacitance in order to receive an accurate response.

It is therefore an advantage to have an electromechanical device which is stretchable repeatedly and which has robust electrical and mechanical connection for an electrical circuit, or at least provide the public with an alternative choice.

### DISCLOSURE OF THE INVENTION

In one aspect the present invention provides a laminated elastic capacitor having a signal electrode and a shielding electrode arranged to provide electrical shielding for the signal electrode, wherein the signal electrode is arranged as a layer of the laminated elastic capacitor, and wherein the laminated elastic capacitor comprises a shielded cable having a signal line and a shielding layer arranged to shield the signal line, and wherein a signal length of the shielded cable has the signal line exposed, and wherein the signal length is arranged as threaded multiple times through the signal layer to provide a connection from the signal layer to an electrical circuit with a shielded signal cable which is integrated into the laminated elastic capacitor.

The integrated shielded signal cable may be calibrated with the laminated elastic capacitor.

The signal length when pulled taught may mitigate stress concentrations in the signal layer to provide a robust mechanical and electrical connection.

The signal length when pulled taught may be forced into firm contact with the signal layer providing robust mechanical and electrical connection.

A shielding length of the cable may have the shielding layer of the cable exposed and the shielding length may be arranged connected to the shielding electrode of the laminated elastic capacitor. This may provide continuous shielding for the signal electrode and signal line of the integrated cable.

The shielding length of the cable may be arranged as threaded through a shielding electrode.

In one aspect the present invention provides an electromechanical device having a conductive component which is and having an conductive lead to connect the component to an electrical circuit, wherein the conductive lead is arranged as threaded through the component at multiple locations on the conductive layer to integrate the lead with the component.

The lead may extend through the conductive layer at multiple locations on the conductive component. This may spread load from the lead. This may spread stress to prevent stress concentrations.

The conductive lead may be arranged as threaded through the component at multiple locations and along alternate surfaces of the lead so as to cause a load applied by the lead relative to the component to compress the component.

The conductive lead may comprise a conductor and an electrically insulating layer and wherein the conductor is exposed to contact the conductive component.

A set of apertures may be formed in the conductive component and the conductive lead may be arranged as threaded through the apertures

The apertures may be arranged in a defined pattern to spread over a region the conductive component mechanical stress applied by the conductive lead to the conductive component.

The electromechanical device may be a laminated stretchable capacitor and the conductive component is an electrode layer of the laminated capacitor.

The lead may be arranged threaded over and under the electrode layer.

The electromechanical device may comprise a first conductive component and a second conductive component and the conductive lead comprises an inner conductor an outer conductor arranged to cover the inner conductor wherein length of the inner conductor which is exposed is arranged threaded through the first component and an exposed length the outer conductor is arranged threaded through second conductive component.

The electromechanical device may comprise a stress-bearing part of the device, the stress-bearing part connected to the conductive component to receive load from the conductive lead and distribute stress to the conductive component.

The conductive component may be elastic wherein a conductive lead arranged to be threaded through the conductive component may be retained in firm electrical and mechanical contact with the conductive component by elastic resilience of the conductive component.

The electromechanical device may be an elastic laminated device and the conductive component is an elastic layer of the laminated device.

The conductive lead may be arranged so as to contact the conductive component between locations through which the lead extends.

The conductive lead may comprise a conductor and an electrically insulating layer wherein the conductor is exposed to allow it to contact the stretchable conductive component when the conductive lead is threaded through the conductive component.

The locations at which the conductive lead extend through the stretchable conductive component may form a defined pattern.

The defined pattern may extend in a direction of stretch relative to the conductive component which stretches in use to spread over a region the conductive component mechanical stress applied by the conductive lead to the conductive component. The region may be a length of the conductive component. In some embodiments the pattern may extend substantially to spread the stress over a length of the conductive component. The region may be an area on the conductive component. In some embodiments the pattern may cover an area to spread the stress over a length and width on the conductive component.

The conductive lead may comprise an inner conductor and an outer conductor.

The outer conductor may cover the inner conductor so as to provide electrical shielding for the inner conductor.

The inner conductor may be coaxial with respect to the outer conductor and separated from the outer conductor by a separating electrically insulating layer.

Alternatively the inner and/or outer conductors may be formed with a ribbon structure.

The electro-mechanical device may be a deformable capacitor, wherein the stretchable conductive component is an electrode.

The capacitor may be a stretchable capacitor.

The capacitor may be a stretchable capacitor which provides a capacitance which varies as the capacitor is stretched so as to allow the connected electrical circuit to instrument a degree of stretch

The conductive component may be formed of threads and the conductive lead may be threaded through apertures formed in the threads of the conductive component.

The conductive lead may be arranged as threaded by weaving.

The conductive lead may be arranged as threaded by sewing.

The conductive lead may be arranged as threaded by threading.

The conductive lead may be arranged as threaded by forming it into a thread-like configuration and embedding it into the conductive component when the conductive component is formed.

The conductive component may be formed of woven threads.

The conductive component may be formed of a non-woven fabric.

The conductive component may be formed of an electrically conductive elastomeric material.

The electromechanical device may comprise a first conductive component and a second conductive component and the conductive lead may comprise an inner conductor an outer conductor arranged to cover the signal conductor wherein length of the signal conductor which is exposed may be arranged threaded through the first component signal and an exposed length the outer conductor may be arranged as threaded through second conductive component.

The conductive component may comprise a signal component and a shielding component arranged to shield the signal component and the conductive lead may comprise a signal conductor and a shielding conductor arranged to shield the signal conductor wherein an exposed length of the signal conductor is threaded through the signal component signal and an exposed length of the shielding conductor is threaded through the shielding component. The shielding conductor may cover the signal conductor.

The conductive lead may comprise a signal component and a reference component to provide an electrical reference for the signal component and may comprise a signal conductor and a reference conductor wherein an exposed length of the signal conductor is threaded through the signal component and an exposed length of the reference conductor is threaded through the an exposed length of the reference component.

The process may comprise arranging as threaded through a stress-bearing component of the electromechanical device, the stress-bearing component connected to the conductive component of the electromechanical device to receive load from the conductive lead and distribute stress to the conductive component.

The stress-bearing component may be connected to the conductive component to transfer and spread stress from apertures formed in the stress-bearing component to the conductive component. In some embodiments the conductive component may receive stress from a combination of the conductive lead arranged threaded through apertures in the conductive component and through connection to the stress-bearing component which receives stress from the conductive lead arranged threaded through apertures formed in the stress-bearing component.

The electromechanical device may provide an interconnect for separate components of the device corresponding to separate conductors of the conductive lead.

Each conductor of the lead may comprise a layer of the conductive lead, wherein the process comprises exposing separate layers of the conductor over separate lengths of the conductor to provide an exposed contact length for each conductor and the process comprising arranging different contact lengths to be threaded through apertures so as to make contact with separate components in the device.

The set of apertures may be separated in the axis of extension.

The set of apertures may be arranged in a defined pattern.

The pattern may be a stitch-pattern.

Stitch pattern may be capable of stretching in one or more directions to accommodate stretching of the conductive component.

The set of apertures may comprise pairs of corresponding apertures on opposite sides of the conductive component of the electromechanical device, wherein apertures in a pair are offset such that a conductive lead extending through the apertures will be at a defined angle with respect to the conductive component.

The conductive component may be elastic, wherein a conductive lead arranged to be threaded through the conductive component may be retained in tight electrical and mechanical contact with the conductive component by elastic resilience of the conductive component.

The conductive lead may be arranged as threaded such that it passes through a stretchable conductive component at multiple points and extends between the multiple points along alternate sides of the conductive component.

In one aspect the present invention provides a process of manufacturing an electro-mechanical device having a conductive component which is stretchable and having a conductive lead to connect the component to an electrical circuit, the process comprising the steps of:

arranging the conductive lead so as to be threaded through the conductive component and so as to electrically contact the conductive component to provide a connection for the electrical circuit.

The process may comprise arranging the conductive lead to extend at multiple locations through the conductive component. The multiple locations may spread stress between the multiple locations applied by the lead to the conductive component.

The process may comprise arranging the conductive lead so as to contact the conductive component between locations through which the lead extends.

The process may comprise providing a conductive lead comprising a conductor and an electrically insulating layer and exposing the conductor to allow the conductor contact the stretchable conductive component when the conductive lead is threaded through the conductive component.

The process may comprise forming a set of apertures in the stretchable conductive component wherein the step of arranging the conductive lead to be threaded through the stretchable conductive component comprises threading the conductive lead through the apertures. Each aperture may be at a location where the lead extends through the conductive component.

The locations at which the conductive lead extend through the stretchable conductive component may form a defined pattern.

The defined pattern may extend in a direction of stretch relative to the conductive component which stretches in use to spread over a region the conductive component mechanical stress applied by the conductive lead to the conductive component. The region may be a length of the conductive component. In some embodiments the pattern may extend substantially to spread the stress over a length of the conductive component. The region may be an area on the conductive component. In some embodiments the pattern may cover an area to spread the stress over a length and width on the conductive component.

The conductive lead may comprise an inner conductor and an outer conductor.

The outer conductor may cover the inner conductor so as to provide electrical shielding for the inner conductor.

The inner conductor may be coaxial with respect to the outer conductor and separated from the outer conductor by a separating electrically insulating layer.

Alternatively the inner and/or outer conductors may be formed with a ribbon structure.

The process of manufacture may be applied to manufacturing an electro-mechanical device in the form of a deformable capacitor, wherein the stretchable conductive component is an electrode.

The conductive component may be formed of threads and the process may comprise arranging the conductive lead so as to be threaded through apertures formed in the threads of the conductive component.

The conductive lead may be arranged by weaving.

The conductive lead may be arranged by sewing.

The conductive lead may be arranged by threading.

The conductive lead may be arranged as threaded by forming it into a thread-like configuration and embedding it into the conductive component when the conductive component is found.

The conductive component may be formed of woven threads.

The conductive component may be formed of a non-woven fabric.

The conductive component may be formed of an electrically conductive elastomeric material.

The device may comprise a conductive adhesive arranged over the threaded inner conductor and/or outer conductor.

The device may comprise an insulating adhesive arranged over the threaded inner conductor and/or outer conductor.

The skilled reader will appreciate that any fabric, woven material or similar may be used to provide the conductive component of the electromechanical device in processes according to the present invention.

The process may comprise exposing a length of inner conductor and arranging the conductive lead such that the one but not the other of the conductors of the lead contacts the conductive component of the device.

The process may comprise:

exposing the inner conductor along a first length of the conductive lead adjacent to a second length of the conductive lead in which the inner conductor remains at least partially covered by the dielectric layer or outer conductor of the conductive lead; and

arranging only the first section to be threaded through the conductive component.

The process may comprise arranging the second length to be threaded through a set of apertures formed in an additional conductive component of the electromechanical device, wherein an outer conductor is exposed along the second length.

The process may comprise arranging a length of the conductive lead through a set of apertures formed in a stress-bearing component of the electromechanical device, the stress-bearing component connected to the conductive component of the electromechanical device. The stress-bearing component may bear stress applied by the second length of lead.

The stress-bearing component of the mechanical device may be formed of a dielectric material.

The stress-bearing component of the electromechanical device may be formed of a matrix material. The conductive component may be impregnated with conductive material to form the conductive component.

The stress-bearing component may be connected to the conductive component to transfer stress from apertures formed in the stress-bearing component to the conductive component. In some embodiments the conductive component may receive stress from a combination of the conductive lead arranged threaded through apertures in the conductive component and through connection to the stress-bearing component which receives stress from the conductive lead arranged threaded through apertures formed in the stress-bearing component.

The reader will appreciate that a length of the conductive lead in which the inner conductor is not exposed will have a greater cross-section. This greater may facilitate apertures in the device bearing stress or forces more robustly.

The process may comprise providing an interconnect for separate components of the device corresponding to separate conductors of the conductive lead.

Each conductor of the lead may comprise a layer of the conductive lead, wherein the process comprises exposing separate layers of the conductor over separate lengths of the conductor to provide an exposed contact length for each conductor and the process comprising arranging different contact lengths to be threaded through apertures so as to make contact with separate components in the device.

The set of apertures may be separated in the axis of extension.

The set of apertures may be arranged in a defined pattern.

The pattern may be a stitch-pattern.

Stitch pattern may be capable of stretching in one or more directions to accommodate stretching of the conductive component.

The set of apertures may comprise pairs of corresponding apertures on opposite sides of the conductive component of the electromechanical device, wherein apertures in a pair are offset such that a conductive lead extending through the apertures will be at a defined angle with respect to the conductive component.

The conductive component may be elastic, wherein a conductive lead arranged to be threaded through the conductive component may be retained in tight electrical and mechanical contact with the conductive component by elastic resilience of the conductive component.

The process may comprise arranging a conductive lead as threaded such that it passes through a stretchable conductive component at multiple points and extends between the multiple points along alternate sides of the conductive component.

As used herein the phrase ‘arranged so as to be threaded’ is used to describe the configuration of the conductive lead with respect to the conductive component and is not intended to be limited to the action of threading, although it may be used to describe this action in some embodiments of the present invention.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 shows an electromechanical device in the form of a capacitor in accordance with an embodiment of the invention;

FIG. 2 shows a conductive lead included in an electromechanical device in accordance with the embodiment of the invention shown in FIG. 1;

FIG. 3 shows an electrode of an electromechanical device in accordance with the present invention with a conductive lead arranged as threaded through the electrode at multiple locations;

FIG. 4 shows the electrode and lead of FIG. 3 pulled tight;

FIG. 5 shows an alternative embodiment to FIGS. 1 to 4 in which an insulated section the lead is used to apply a portion of stress to the electrode;

FIG. 6 shows an electrical mechanical device in the form of a stretchable capacitor according to an alternative embodiment of the invention to that shown in FIG. 1;

FIG. 7 shows a conductive lead according to an alternative embodiment of the invention to that shown in FIG. 2;

FIG. 8 shows a stretchable component in the form of an electrode according to an additional this embodiment of the invention to that shown in FIGS. 1 to 7;

FIG. 9 shows a stretchable component in the form of an electrode according to an additional embodiment of the invention to that shown in FIGS. 1 to 8;

FIG. 10 shows a stretchable component in the form of an electrode according to an additional embodiment of the invention to that shown in FIGS. 1 to 9;

FIG. 11 shows a stretchable component in the form of an electrode according to an additional embodiment of the invention to that shown in FIGS. 1 to 10;

FIGS. 12, 13, 14 and 15 show a stretchable component with alternative specific arrangements of threading of conductive lead according to additional embodiments to that shown in FIGS. 1 to 11;

FIGS. 16, 17, 18 and 19 shows steps in a process of fabricating an electromechanical device in the form of a stretchable capacitor according to an additional embodiment of the present invention to that shown in FIGS. 1 to 15;

FIGS. 20, 21, 22 and 23 show example electromechanical devices in the form of stretchable capacitors according to alternative embodiments of the invention to those shown in FIGS. 1 to 19;

FIG. 24 shows an example of an electromechanical device according to a further alternative embodiment to those shown in FIGS. 1 to 23.

Further aspects of the invention will become apparent from the following description of the invention which is given by way of example only of particular embodiments.

### BEST MODES FOR CARRYING OUT THE INVENTION

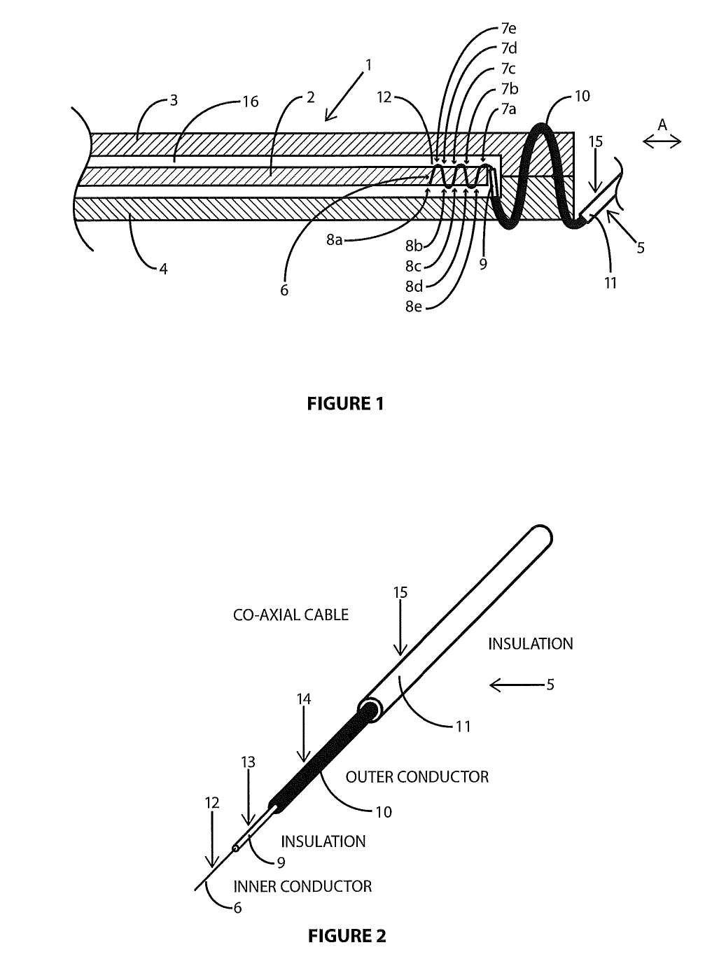

FIG. 1 shows an electromechanical device 1 which has a conductive component 2 in the form of a stretchable electrode. In this example, the electrode is formed of a matrix material which is impregnated with a conductive material. In this example also, the electromechanical device 1 is intended in use to stretch and to return to its original configuration in direction A. In this specific example, the electrical mechanical device is intended to stretch and return resiliently after a large number of cycles.

Also in the specific example shown in FIG. 1, the conductive component is an electrode of a stretchable capacitor. The conductive component is intended to stretch correspondingly. In this specific example the electromechanical device is a sensor and the stretchable conductive component provides an electrical signal for an electronic circuit (not shown). The sensor is formed of highly stretchable material.

Also in this specific example a corresponding pair of stretchable capacitive electrodes 3 and 4 provide a capacitance with the electrode 2 which varies as the electromechanical device 1 is stretched to change the overlapping area of electrodes 3 and 4 with electrode 2 and also the distance between the electrodes. These electrodes also serve to enclose the electrode 2 to shield it electrically.

In this specific example the sensor is intended for use in instrumenting stretches in the order of the length of the device 1, or less. The reader will also appreciate that such an electrode, formed of stretchable material may be susceptible to degradation by stress applied to the electrode by any mechanical or electrical connections. This is particularly the case of the present example which is intended to be stretched in use over repeated cycles.

The electromechanical device one has a conductive lead 5 to provide a connection for the electrical circuit (not shown). The conductive lead 5 has an inner conductor 6 to electrically connect the conductive component 2 to the electrical circuit (not shown). In this example, the conductive component 2 provides a signal for the electrical circuit (not shown) and the inner conductor acts as a signal line.

As shown in FIG. 1, the inner conductor 6 extends through the conductive component 2 at multiple locations 7a to 7e on one side of the component 2 and corresponding locations 8a to 8e on the opposite side of the component 2. The configuration of the inner conductor 6, with respect to the component 2 may be described as threaded. FIG. 1 shows the inner conductor 6 following a tortuous path down of the component 2. The reader will appreciate that this tortuous path will spread stress applied by the inner conductor 6 to the component 2 and provide an extended contact area between the inner conductor 6 and the component 2.

FIG. 2 shows a closer view of the conductive lead 5 of the specific embodiment of the present invention. The conductive lead 5 has an inner conductor 6 which is covered by an intermediate insulator 9. The lead 5 is shown in FIG. 2 as it is provided for arrangement into a threaded configuration with the conductive component 2 of the electromagnetic device 1 in FIG. 1. In this state, the lead is provided with the inner conductor 6 exposed over a length 12. In this example, the inner conductor 6 is exposed by stripping back the insulation 9 over a length 12. The conductive lead 5 shown in FIG. 2 has an outer conductor 10 and outer intermediate insulator 11. As shown, the insulator 9 is intermediate to the inner conductor 6 and outer conductor 10. As shown in FIG. 2, the intermediate insulator 9 has been exposed from the outer conductor 10 and the outer conductor has been exposed from the outer insulator 11 over a length 13. Similarly, the outer conductor 10 is shown exposed from the outer insulator 11. As shown, the remaining length 15 of the conductive lead 5 has the outer insulator 11 exposed.

In this specific example shown in FIG. 2, the inner conductor 6 is coaxial with respect to the outer conductor 10. As the reader will understand, the outer conductor 10 may provide shielding for the inner conductor 6 acting as a signal line. As the reader will also understand, the inner conductor 6 and outer conductor 10 may provide a duplex pair of signal lines. In the example shown, the electrode is shielded by the electrodes 3 and 4 and the inner conductor is shielded by the outer conductor 10, so the entire device including inner conductor 6 may be shielded.

As shown in FIG. 1, the separate lengths of lead 12 to 15, of various exposed layers are used to connect separate components of the electromechanical device 1, which in this case is a stretchable capacitor. As shown in FIG. 1 the length 12 of the lead 5 is connected to the electrode 2. As shown also the intermediate insulator section 13 is connected to a layer of insulator material 16 which separates the electrode 2 from the electrodes 3 and 4. It will be apparent to the reader that the section 12 might be connected also to the layer 16 because the material 16 is has an insulating characteristic. However it will also be apparent to the reader that the intermediate insulator 9 increases the cross-section of section 13 compared to section 12. It will also be apparent that the section 13 separates section 12 from the electrodes 3 and 4. Additionally, it will be apparent that a part of the insulating layer 16 located at the end of the electrode 2, where the formation of the capacitor 1 is likely not intended to be measured, the insulator 16 to device to may potentially be thicker and mechanically more robust than the electrode 2. These properties of the section 13 and insulating layer 16 facilitate a stress-bearing function of the section 13 and part of the insulating layer 16. This is, a part of the insulating layer 16 connected to the end of the electrode 2 receives stress applied by the section 13. As it is connected to the electrode 2 stress can be transferred to the electrode 2 with reduced risk of damage to the, typically thin, electrode 2.

FIG. 1 also shows outer-conductor section 14 connected to electrodes 3 and 4. In this embodiment, the electrodes terminate at an end of the capacitor 1 which provides a dual purpose of an electrical connection of the electrodes 3 and 4 and also stress-bearing for the capacitor one, and specifically electrodes 3 and 4 and electrode 2.

As shown in FIG. 1, the electrodes 3 and 4 surround the electrode 2 and provide a termination which serves a dual purpose of an interface for connection of the electrodes 3 and 4 to the outer conductor 10 and also a stress-bearing for the capacitor 1.

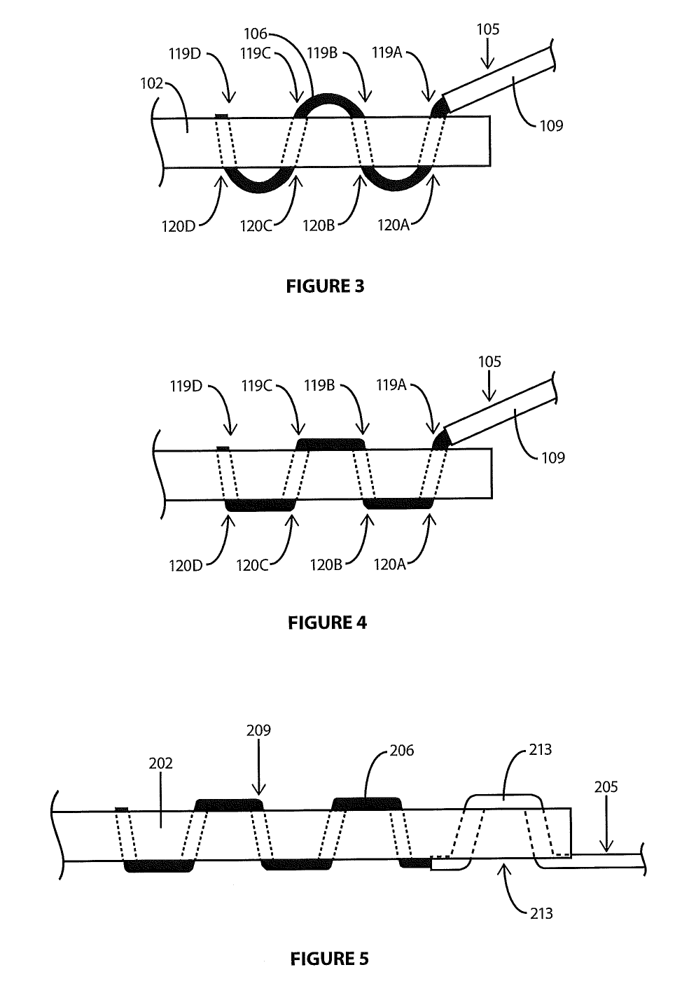

FIG. 3 illustrates connection of the conductor 106 and electrode 102, or other conductive component, according to another embodiment of the present invention. In this example, the inner conductor 106, has been arranged in a threaded configuration through the electrode 102 by a threading operation. FIG. 3 shows multiple locations 118a to 118d where the inner conductor 106 extends through the electrode 102. FIG. 3 also shows apertures 119a to 119d on a first side of the electrode 102 and apertures 120a to 120d on the opposite side of the electrode 102, through which apertures the inner conductor 106 is threaded. As shown in FIG. 3, apertures 119 are offset horizontally with respect to the page from apertures 120 so that the conductor 106, in its threaded configuration, is angled with respect to a plane formed as shown by the electrode 102. In the example shown passages between corresponding apertures on the 9 and 120 are at an obtuse angle to the plane of the electrode 102.

FIG. 4 shows the inner conductor 106 in a threaded configuration after the conductor 106 has been pulled tight, or tightened by other means known to the reader, so that it is in firm contact with the electrode.

Typically this is not only at locations of apertures 119 and 120 but in contact regions intermediate of those apertures. As will be understood by the reader, the inner conductor 106 may be held firmly in contact with opposite surfaces of the electrode 102 by an elastic property of the electrode 102.

FIG. 5 shows an alternative embodiment to that shown in FIGS. 3 and 4. In this embodiment, a lead having an exposed inner conductor 206 at section 209 is threaded through an electrode 202. A section 213 of the lead 205 in which an insulator of lead 205 is exposed is arranged threaded through the same electrode 202. This embodiment the section 213, which typically has a greater cross-section then the section 209, acts to bear stress applied to the electrode 202 by the lead 205.

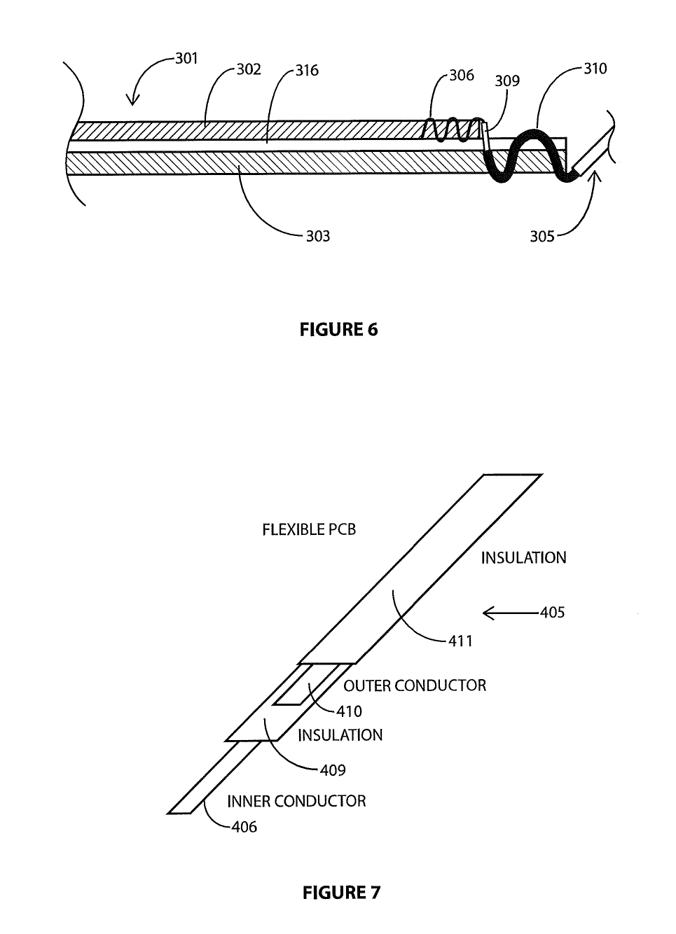

FIG. 6 shows a capacitor 301 with connecting lead 305 according to an alternative embodiment. The capacitor has an electrode 302 and an electrode 303. The electrodes 302 and 303 are separated by an insulator of dielectric material 316. The lead 305 has an inner conductor section where an inner conductor 306 is exposed, an insulator section where the inner conductor 306 is covered only by an inner or intermediate insulator 309. The lead 305 also has an outer conductor section where an outer conductor 310 is exposed. Finally, the lead to 305 has a remaining section where an outer insulator 311 covers the outer conductor 310. As shown in FIG. 6, the inner conductor section is arranged as threaded through and along the length of the electrode 302. The intermediate insulator section 313 is arranged as threaded through the insulator 316. The outer conductor 310 section is shown as threaded through the electrode 303 to provide electrical connection of the electrode 303. In this specific example the outer conductor section is also threaded through the insulator 316. In this example the capacitor 301 is terminated with a tab in which the insulator 316 and electrode 303 extend beyond the electrode 302 to provide a stress-bearing tab or termination for the capacitor 301.

Also shown in FIG. 1, the outer conductor section 10 of the lead is connected to the electrodes 3 and 4 at an end of the capacitor 1.

FIG. 7 shows a conductive lead 405 in the form of a ribbon which may be used as an alternative to the lead 5. The conductive lead 405 is formed of a ribbon of flexible printed circuit board (PCB). The conductive lead 405 has an inner conductor 406 and intermediate insulator 409 and outer conductor 410 and an outer insulator 411.

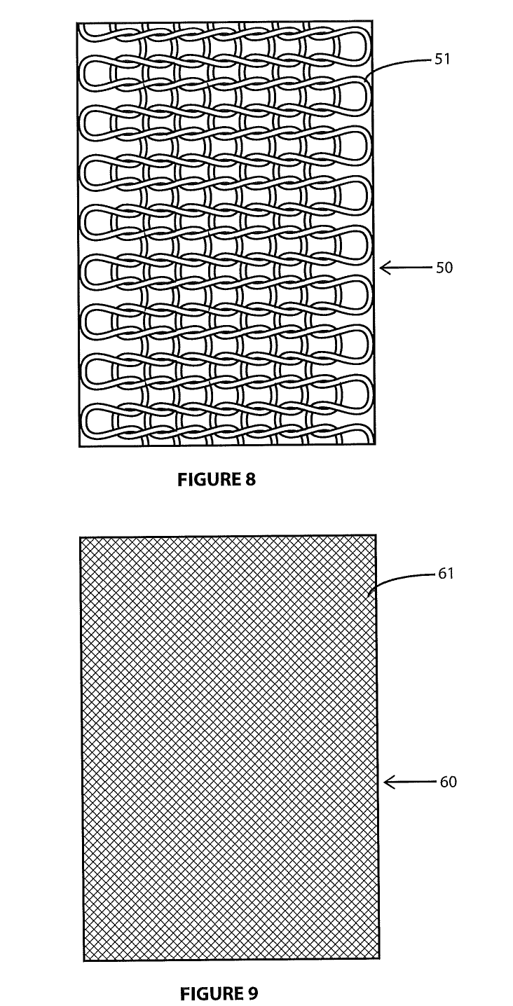

FIGS. 8, 9, 10 and 11 show various examples of materials and composites that are appropriate for stitched connectors. FIG. 8 shows an electrically conductive fabric 50, specifically a stretch fabric in this example, that is able to stretch in each of its planar dimensions due to a knitted structure and elastic threads 51.

FIG. 9 shows a mesh 60 to that is able to stretch and is well suited to connections for electrical circuits provided by a conductive lead which is arranged threaded through the mesh by a stitching operation. The lead, especially where its diameter is comparable to the thickness of the fabric or the diameter of fibers 61 used in the fabric, may easily be arranged to be threaded through the fabric by displacing the fibers of the fabric to make room for the cable.

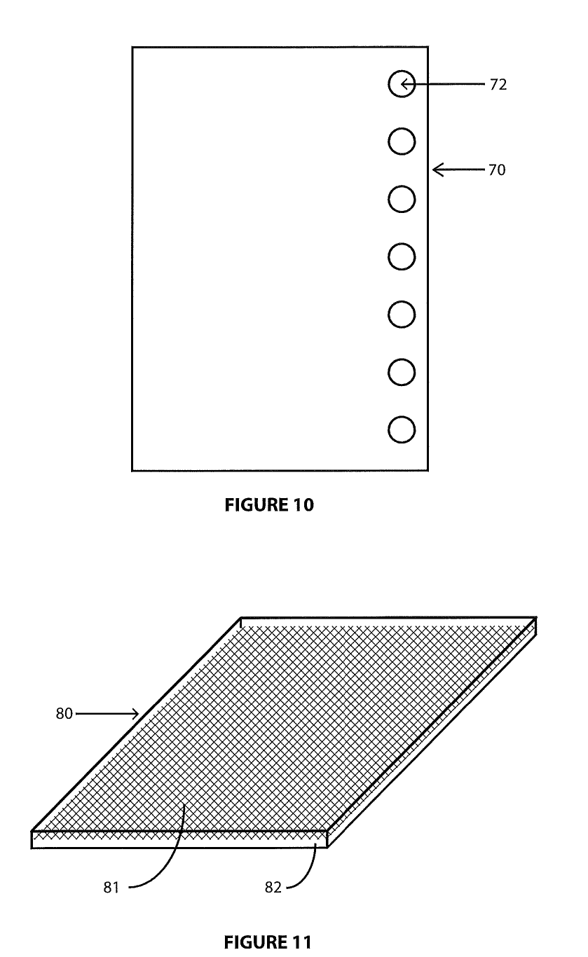

FIG. 10 shows an alternative to a fabric in the form of a solid, flexible and compliant material 70. In this example this the material is an elastomer for example, which itself may be a composite of electrically conductive materials embedded in an elastomeric matrix. However, the act of penetrating the material by stitching in the lead may create tear nucleation points. These are points from which tears propagate when the layer or the lead is loaded mechanically. It may be possible to use a material with a high tear strength, such as a material that has silica particles embedded that act as rip stops. However, it is more reliable to add additional features such as apertures 72 that have smooth/rounded walls and not sharp corners smooth rounded corners may prevent tear nucleation.

FIG. 11 shows a compound material 80, stretchable fabric or mesh 81 is embedded in in a matrix material such as silicone 82 to act as reinforcement. In these embodiments additional strength of fibers in the embedded fabric may prevent tears from propagating and causing large scale mechanical failure. Where a fabric or mesh is embedded in a matrix material, one or both of the fabric or the matrix material can be electrically conductive, provided the act of sewing, knitting or weaving to arrange the conductive lead to be threaded into the layer brings the relevant exposed electrical conductor of the lead in contact with its relevant layer such as a layer of conductive material providing an electrode of a capacitor for example this. Note combinations of one or more of a stretchable fabric, mesh, functional apertures, or an elastomeric matrix to prevent tearing can may be used if appropriate.

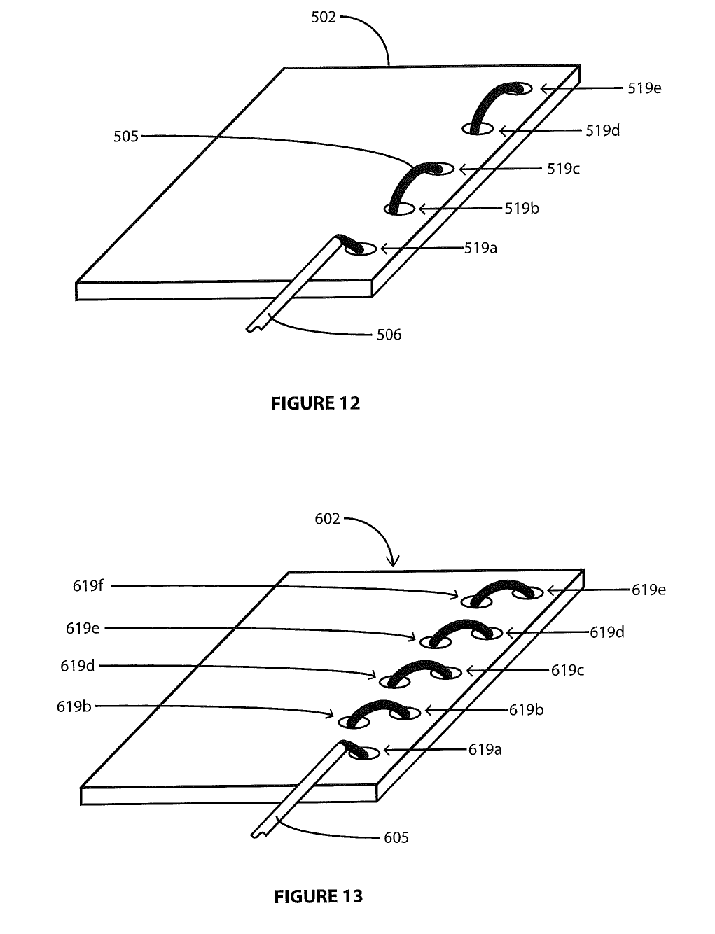

FIGS. 12, 13, 14 and 15 to show various stitch patterns, or patterns of apertures in a conductive component, in which a conductive lead may be arranged.

FIG. 12 shows an electrode 502 with a straight line of apertures 519a to 519e through which an inner conductor 505 of a conductive lead 506 is arranged as threaded in a straight stitch pattern.

FIG. 13 shows an electrode 602 with two rows of apertures 619a to 619i. FIG. 13 shows an inner conductor 606 of the conductive lead 605 threaded between these rows in a zigzag stitch pattern.

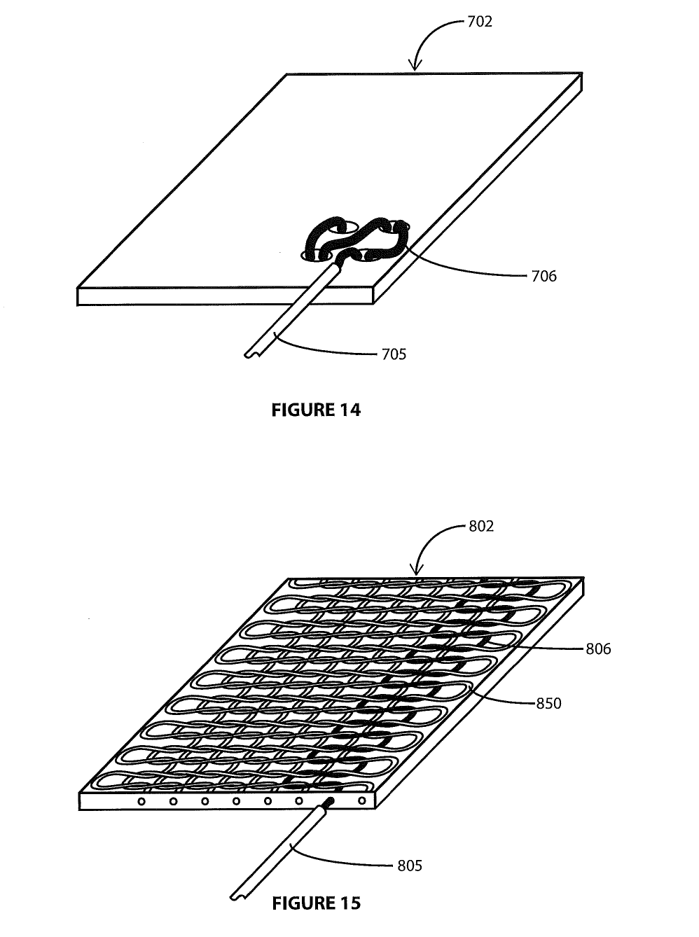

FIG. 14 shows an electrode 702 into which an inner conductor 706 of the conductive lead 705 is arranged as threaded in a repeated stitch pattern.

FIG. 15 shows an electric electrode 802 formed of knitted conductive fibers 850 and shows an inner conductor 806 arranged as threaded in the specific configuration which mimics the knitted pattern of the electrode 802. In this embodiment the inner conductor 806 may form part of a structure which can more is easily deformable with the electrode 802. The threaded conductive lead may be referred to as being in a ‘knitted’ configuration. Note, a knitted configuration may not be restricted in various embodiments to a stretchable fabric capacitor layer. Embedding a knitted conductive lead into an elastomer matrix, for example, would similarly allow the signal line to bend and flex to accommodate deformation of the elastomer without requiring the signal line itself to stretch. Alternative stitch patterns known by those skilled in the art may also be used without departing from the scope of the invention.

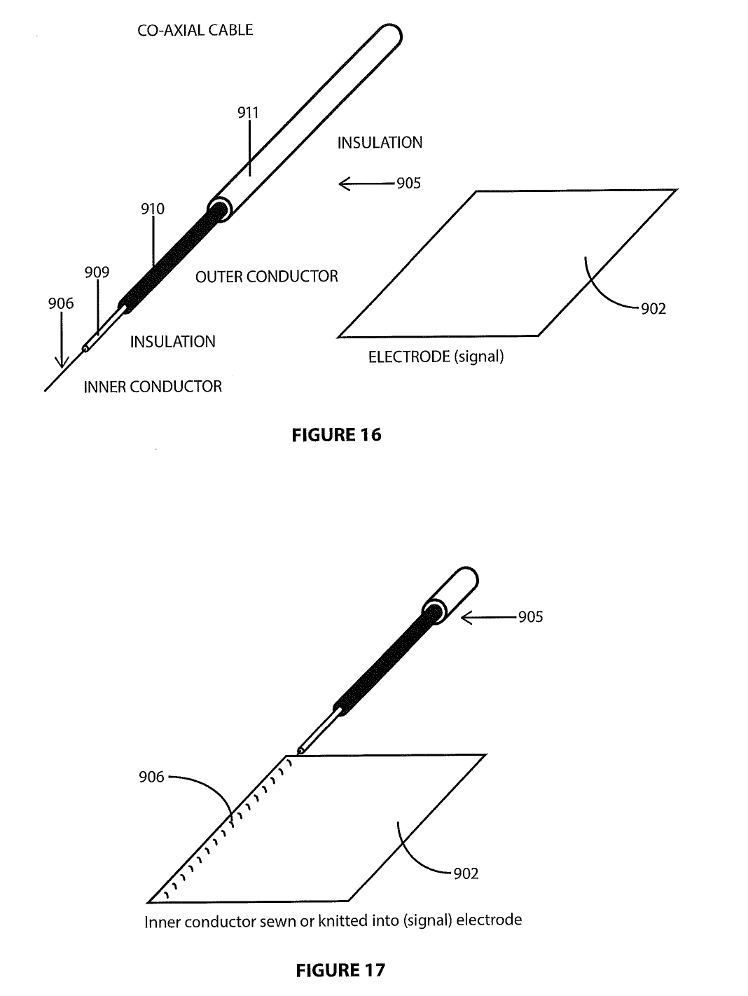

FIGS. 16, 17, 18 and 19 shows stages of fabricating an electromechanical device in the form of a stretchable capacitor 901, shown in FIG. 19.

FIG. 16 shows a step in which a conductive lead 905 is provided with different layers of the conductive lead 905 exposed over different lengths, from an inner conductor 906 and intermediate insulation layer 909, an outer conductor layer 910 and an outer insulation layer 911.

FIG. 17 shows a step in which an inner conductor 906 of conductive lead 905 is arranged as threaded through an electrode 902 of the capacitor to be fabricated 901, shown in FIG. 19. In this specific embodiment the inner conductor 906 is arranged as threaded with a stitching operation. This step may be referred to as stitching a signal line to a signal layer 902 of a capacitor.

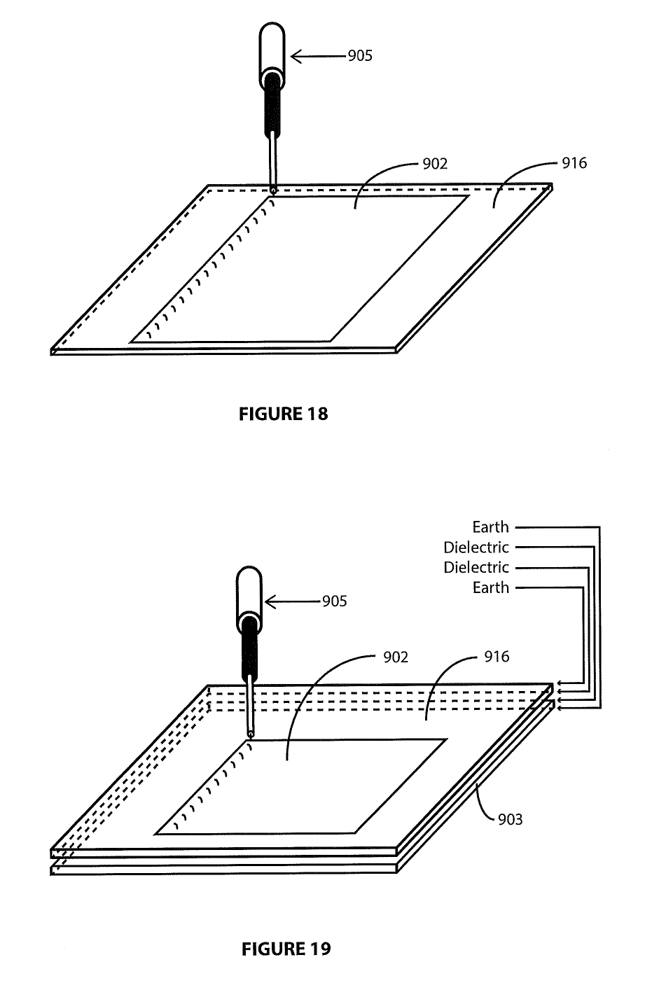

FIG. 18 shows a step in which an insulating layer 916 is applied to the electrode, or signal layer, of the capacitor to electrically insulate the electrode and the inner conductor 906 of the conductive lead 905. In order to approximate the behavior and properties of an ideal capacitor with it is necessary that there are no substantially electrically conductive pathways between electrodes of opposite polarity. This is, between layers of a stretchable capacitor. It is important that there is no direct mechanical connection and therefore no low resistance electrical contact between the electrode 902 connected to the inner conductor 906 and either an electrically conductive shield/earth electrode or conductor/shield 910 of the lead 905. In order for this to happen it is necessary to place an electrically insulating barrier over both the signal layer of the capacitor and the signal line of the cable. In this example insulating barrier is in the form of an electrically insulating encapsulant material, such as silicone or other material known to the reader that is stretchable, flexible, compliant or combination of these. As the reader will appreciate various designs of the capacitor will dictate these properties, such as stretchable, flexible or compliant or combination. It is important, however, that this layer does not fully encapsulate the exposed electrically conductive shield on the cable so that it may still be connected to the shield/earth layers of the capacitor.

FIG. 19 shows an additional step in which an additional electrode 903 for earthing or shielding for example, and an insulator are added in the form of conductive electrode layers and dielectric layers. As described above, the conductive lead is arranged as threaded through these additional layers with different lengths of the cable 905, with various exposed intermediate insulator 909, out to conductor 910, and outer insulator 911 being in contact with various layers of the capacitor as illustrated with reference to FIGS. 1 to 15.

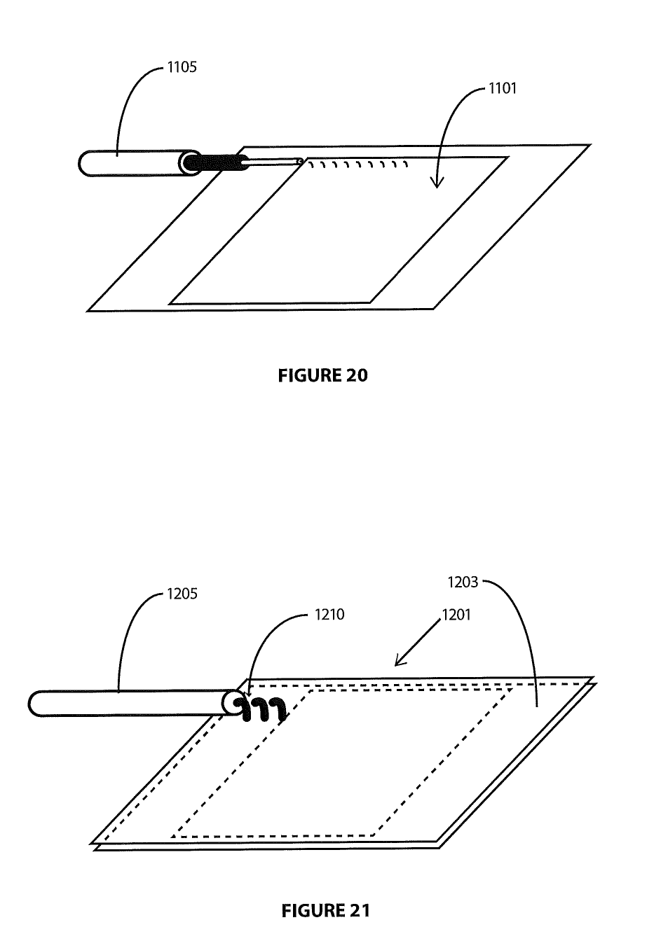

FIGS. 20, 21, 22 and 23 show examples of electromechanical devices in accordance with embodiments of the present invention, in the form of a stretchable capacitor, with conductive leads integrated into the corresponding layer of the flexible and compliant capacitor in a variety of orientations.

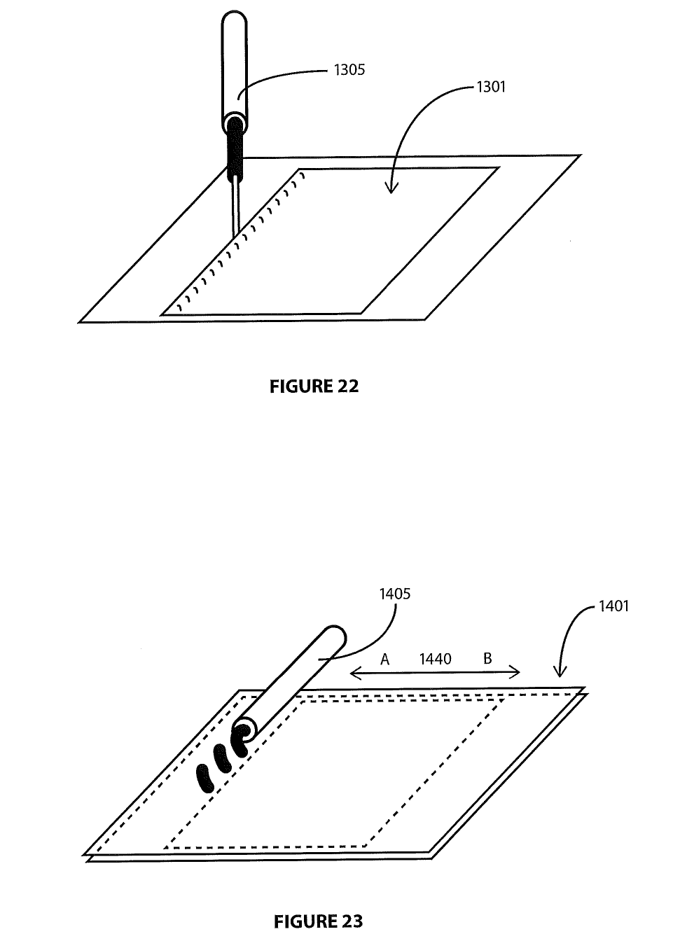

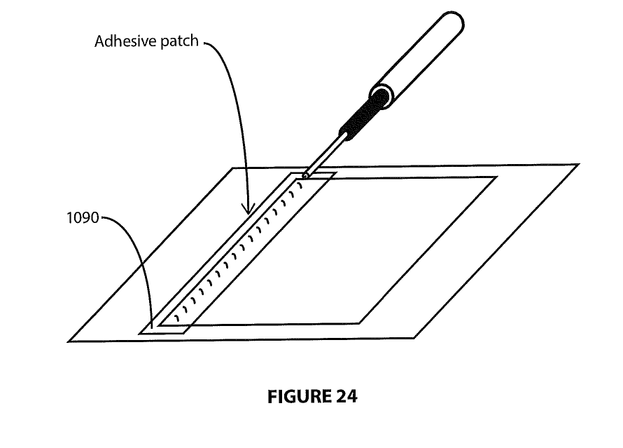

The orientation of the connection between the cable and the capacitor can be designed or modified in order to fit with other design criteria of the capacitor. FIG. 20 shows inner conductor of lead 1105 stitched into signal electrode 1101 and arranged in plane with signal electrode 1101. FIG. 21 shows a capacitor 1201 formed by a shielding electrode 1203 stacked on top of the signal electrode 1101 shown in FIG. 20 and separated by an insulating layer (not shown) with the outer conductor 1210 of lead 1205 stitched into the shielding electrode 1203. A perpendicular orientation is illustrated in FIG. 22, with the lead 1305 perpendicular, or at least not parallel with, to the plane of the signal electrode 1301. Another orientation is shown in FIG. 23 with a lead 1405 in the plane of the device 1401 but perpendicular to a direction of deformation 1440. However, it will be appreciated by the reader art that other orientations are possible without deviating from the scope of the present invention.

FIG. 24 shows a signal electrode 1001 with the inner conductor 1011 of lead 1010 stitched into it with an additional adhesive layer 1090 to further enhance the robustness of the connection between the cable and the flexible and compliant capacitor according to an additional embodiment. In this embodiment, and adhesive layer 1090 is applied over a region of the electrode through which a conductive lead is arranged as threaded. For electrically conductive sections, an electrically conductive adhesive will serve to further reduce the chances of the cable substantially moving relative to the capacitor, and will create electrically conductive pathways from the conductive components of the cable that are not already in direct contact with the electrically conductive layers of the capacitor. This adhesive may come in the form of an electrically conductive liquid adhesive, glue, or tape for example. Alternatively, the electrical connection between the cable and the capacitor may require no electrical enhancement, and a non-electrically conductive adhesive, glue, or tape could be applied to further secure the connection between the cable and the capacitor.

Further and additional embodiments are described below.

Embodiments of the present invention, similar to that shown in FIG. 1 provide a shielded sensor with integrated shielded cable with signal layer and the signal line are shielded at all times from external electrical noise by the electrically conductive shield layer of the capacitor and the shield layer in the cable. The signal layer, including the region corresponding to the integrated signal line, is covered by the capacitor's electrically insulating dielectric material. The remaining length of the cable, including the section with the exposed electrical shield is itself stitched or woven into the shield layer of the capacitor, which has been wrapped around the outside of the electrically insulating dielectric layer. Alternative stitch patterns such as the examples provided in FIGS. 12 to 15, or others known to the reader, may be used to secure the conductors of the cable to the relevant electrically conductive layers of the capacitor. Furthermore, as described with reference to FIG. 4, part of the layer insulating the signal line, and the layer insulating the cable shield may be stitched into one or more layers of the capacitor for additional mechanical robustness. In some applications of various embodiments, it may only be necessary to partially shield the sensor from external sources of electromagnetic noise. This is, it may only be necessary to shield one side of the flexible and compliant capacitor. FIG. 6 shows an example of a partially shielded variant of the completely shielded capacitor and cable from FIG. 1.

In various embodiments stitch patterns will result in the relevant section of the cable passing through the layer of the capacitor in multiple locations at multiple angles, and along multiple different axes relative to the angle with which it first enters the layer. Doing so creates multiple points of contact for both electrical and mechanical robustness, and reduces the possibility of the cable pulling out when the mechanical load is applied to the stitched region. Further the stitch pattern could be selected such that the cable does not substantially restrict the deformation of the capacitor. This is stretching of the capacitor translates to bending and flexing of the cable, and thus the stitched region is capable of stretching even though the cable itself may not be stretchable. Alternatively in various embodiments the stitch pattern may be confined to an arbitrary outline with a small area relative to the area of the electrode to ensure the stitch only affects a small proportion of the capacitor layer.

Embodiments of the present invention use as a conductive lead a shielded coaxial cable, similar to that shown in FIG. 2, that has had the various layers selectively stripped to expose them in such a way that makes it convenient for use in the connection process. A portion of the inner electrically conductive signal line is exposed by removing all of the outer layers surrounding it. Each subsequent layer, starting with the insulating layer of the signal line and progressing to the electrically conductive shielding layer is similarly exposed by removing a portion of the layers outside of them.

Embodiments of the present invention use as a connection lead a flexible printed circuit board elements similar to that shown in FIG. 7. The inner signal trace is exposed, followed by a section of the lead where the signal trace is insulated from its surroundings by an electrically insulating layer, followed by a section of the lead where the electrically conductive shield is exposed, followed by the main section of the lead in which the electrically conductive shield is insulated from the outside world by a second electrically insulating layer.

In various embodiments of the invention the conductive lead may be arranged as threaded through a conductive component to fix the lead to the relevant layer of the capacitor by a number of stitch patterns. In some embodiments, the stitch pattern will result in the relevant section of the lead passing through the layer of the capacitor in multiple locations at multiple angles, and along multiple different axes relative to the angle with which it first enters the layer. This provides multiple points of contact for both electrical and mechanical robustness, and reduces the possibility of the lead pulling out when the mechanical load is applied to the stitched region. Further the stitch pattern could be selected such that the lead does not substantially restrict the deformation of the capacitor. This is stretching of the capacitor translates to bending and flexing of the lead, and thus the stitched region is capable of stretching even though the lead itself may not be stretchable. Alternatively the stitch pattern could be confined to an arbitrary outline with a small area relative to the area of the electrode to ensure the stitch only affects a small proportion of the capacitor layer. In FIG. 6 some simple example stitch patterns are shown. Stitch patterns could include a straight stitch (FIG. 6, top-left), a zig zag stitch FIG. 6, top-right), or a repeated stitch (FIG. 6, bottom-left), or the lead could be integrated into the capacitor layer in a configuration that mimics that of a single course in a knitted structure (FIG. 6, bottom-right), thereby creating a structure that can more easily deform with the capacitor layer. Note a “knitted” signal line configuration is not restricted to a stretchable fabric capacitor layer, embedding a knitted signal line into an elastomer matrix, for example, would similarly allow the signal line to bend and flex to accommodate deformation of the elastomer without requiring the signal line itself to stretch. Alternative stitch patterns known by those skilled in the art may also be used without departing from the scope of the invention.

In various embodiments of the invention the conductive lead may be a cable including a conductive lead and including layers providing various mechanical properties as will be understood as desirable by the reader.

Various embodiments of the present invention a conductive line of a conductive lead may be a trace of a printed circuit board, for example.

In some embodiments of the present invention and exposed signal line of the coaxial lead being stitched into the signal layer of the capacitor similarly to that shown in FIGS. 3 and 4. When the stitch is pulled tight, the signal line is brought into close contact with the signal layer. The contact area between the signal line and the signal layer is proportional to the length of the signal line that is in contact with it. A higher contact area reduces the electrical impedance of the connection between the signal line and layer. Furthermore, having a longer length of the signal line in contact with the signal layer provides greater redundancy should part of the signal line slip relative to the signal layer and result in localised loss of contact between the line and layer, especially as the line or layer is loaded mechanically. The impact of a small section losing contact on the overall electrical impedance is reduced by a longer length. Increased contact area also increases friction and thus the force required pull the lead from the layer. Similarly, the non-linear path the signal line takes through the signal layer provides further retention capability that assists in preventing the signal line from being pulled free, while at the same time supporting the signal line and making it less likely to kink or bend into a very small radii that may lead to the signal line mechanically breaking. Note the same benefits similarly apply to the stitching of the lead into the shielding layers of the flexible and compliant capacitor to mechanically and electrically connect the shielding of the lead to the shielding of the capacitor.

In some embodiments, similar to that shown in FIG. 4 the signal line of conductive lead is stitched into the signal layer of the capacitor so that part of the exposed electrically insulating layer of the section of the lead is also stitched into the signal layer. By virtue of having a greater cross-sectional area, the section of lead with the exposed electrical insulation layer is more robust than the exposed signal line alone. This enhances the benefits as outlined for FIG. 3—the insulated section provides greater strain relief to the exposed signal line threaded through the signal layer.

In various embodiments of the invention and electromechanical device, sensor or capacitor, or the various components or layers of these referred to above may be flexible and compliant.

In various embodiments of the invention and electromechanical device, sensor or capacitor, or the various components or layers of these referred to above may be elastic.

The reader will appreciate that an outer conductor of the conductive lead may cover an inner conductor 116 but not necessarily surround it.

In some embodiments apertures formed in an electrode, or other conductive component, may be offset from corresponding apertures on an opposite side of the electrode into axes, such as will be shown horizontally with respect to the page in FIG. 3, for example, and also into the page as shown in FIG. 3. The reader will appreciate that an offset into the page as well as horizontal with respect to the page will cause strain applied by a conductive lead to an electrode to be spread over an area of the electrode.

The reader will appreciate that a conductive component may provide an electrical signal as it deforms, and may be referred to as a signal component and a conductor of a conductive lead may be referred to as a signal line. The reader will appreciate that a conductive component which is an electrode of a capacitor may provide a signal through variation in capacitance across the electrode and another electrode as the electromechanical device is deformed to vary the geometry of the capacitor.

The reader will appreciate that a conductive component may provide a change in resistance as the electromechanical device deforms which may alter the signal provided by a change in capacitance.

In alternative embodiments the electro-mechanical device may be an actuator, which is actuated by electrostatic forces imparted to stretchable electrodes carrying electrical charge.

In some further and additional embodiments the stretchable conductive component may be a stretchable resistor. In these embodiments a signal lead may be replaced with a power lead to carry power to generate the charge on the electrodes.

In some further and additional embodiments the stretchable conductive component may be a component arranged to have a resistance, impedance or other electrical characteristic.

In alternative embodiments the conductive lead may be arranged so as to be threaded through the stretchable conductive component by forming the conductive component with the conductive lead in place. In one embodiment the conductive lead may be arranged using a loom while the conductive component is cast around the lead.

In alternative embodiments the conductive lead may be arranged in a tortuous path through the conductive component, without necessarily extending through the component, or at least not necessarily at multiple locations.

In some embodiments, such as exemplified in FIG. 4, a lead is arranged threaded through the conductive component layer and extending on alternate sides of the layer between locations of apertures through which the lead extends through the layer. In the example shown in FIG. 4 the lead is arranged threaded under and over the electrode. A load on the lead relative to the layer will tend to straighten the lead forcing sides of the elastic layer together. In various embodiments, this effect will distribute stress to mitigate tearing for example or to have other advantages which will be apparent to the reader.

Embodiments of the present invention provide a flexible and compliant electromechanical device, such as a capacitor for example, with a connection for an electrical circuit which is compact and robust both mechanically and electrically. These embodiments do not rely on a single point of contact which may be disadvantageous if that single point degrades over time. This is, a single point of contact concentrates the transmission of mechanical load between each component at the connection, resulting in high stresses that increase the chance of mechanical failure. Embodiments mitigate the effect that any variation to a single point of connection can have a significant effect on the electrical connection between the components, which in turn may lead to an electrical failure or unacceptable degradation or loss of communication between the components. Embodiments provide multiple connections to provide both electrical and mechanical redundancy. Additional mechanical fastening mechanisms such as clamps, crimps, or staples for example, can reinforce this region, but where size minimisation and the elimination of hard components are important these features are not ideal and embodiments provide an alternative. Embodiments of the invention provide an alternative to adhesive, which may not may provide sufficient mechanical and electrical connection, particularly if volume constraints limit the amount of adhesive that can be used. Any degradation of the adhesive, whether due to mechanical loads or age, typically causes mechanical loads to be concentrated on a smaller and smaller section of adhesive, increasing the chances of failure over time or with sequential loading cycles.

Embodiments of the invention provide for integration of a connector into a stretchable, or flexible and compliant circuit accounting for the mechanical integrity of the circuit itself. Embodiments overcome a tendency for flexible and compliant circuits made from elastomeric materials, for example, to be highly susceptible to failure from mechanical defects in the elastomeric layers. For example, rough edges, air pockets, dust/contaminate particles, and holes can create stress concentrations that cause premature mechanical failure when the circuit is deformed. This is, they may create a point from which a tear in the material will start. Even if a tear grows only by a small amount each time the circuit is deformed, as the tear grows the mechanical loading forces will be concentrated over a smaller and smaller area and thus promote further tearing on subsequent deformations. Embodiments of the present invention allow integrating a connector into such a circuit while arranging the circuit and the connector, including the materials selection and form factor, to ensure that the connection does not cause premature failure in the integrated structure.

Embodiments of the present invention obviate the need for direct connection of a rigid connector component to a stretchable electromechanical device, which may create a mechanical stress concentration that results in a connection interface degrading with repeated mechanical cycling of the circuit, leading to mechanical and/or electrical failure of the connection and failure of the device.

In some embodiments apertures are formed prior to the additional of the lead. In alternative embodiments the apertures are formed during a threading operation.

It will be apparent to the reader that in various embodiments described herein a length of the conductor of the lead is arranged as threaded over and under a given layer of the capacitor, or other electromechanical device. It will also be apparent that in various embodiments described herein the length of conductor is confined within an insulating layer adjacent the electrode so that the conductor of the lead itself is insulated from other electrodes in the capacitor.

Embodiments of the present invention provide an electromechanical device, such as a laminated elastic capacitor with a robust mechanical and electrical connection of a signal electrode within the capacitor and an integrated shielded lead, wherein continuous shielding is provided for the signal electrode and integrated signal line of the lead. This facilitates calibration of the integrated capacitor and cable. Embodiments of the present invention comprise a packaged product comprising the electromechanical device of any of the embodiments described herein and a data storage or display medium carrying calibrated capacitance data.

In various embodiments different forms of deformation may be measured. In some alternative embodiments to those described above the sensor is arranged suitable for detecting compression rather than stretching. In these embodiments compression alters the geometry of a capacitor formed by layers of the sensor. This may change the capacitance in the sensor as understood by the reader.

In some embodiments a length of inner conductor or outer conductor to be arranged threaded through a corresponding electrode is selected dependent on the thickness of the electrode, the tear-related properties of the electrode material, the degree of deformation of the device to be instrumented by a connected circuit, the number of cycles of deformation expected or a combination of these.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1. A laminated elastic capacitor having a signal electrode and a shielding electrode the shielding electrode arranged to provide electrical shielding for the signal electrode, wherein the signal electrode is arranged as a layer of the laminated elastic capacitor, and wherein the laminated elastic capacitor comprises a shielded cable having a signal line and a shielding layer arranged to shield the signal line, and wherein a signal length of the shielded cable has the signal line exposed, and wherein the signal length is arranged as threaded multiple times through the signal layer to provide a connection from the signal layer to an electrical circuit through a shielded signal cable which is integrated into the laminated elastic capacitor.

2. The laminated elastic capacitor of claim 1, wherein the cable comprises a shielding length with the shielding layer exposed and arranged in contact with the shielding electrode of the laminated elastic capacitor to provide continuous shielding over the signal layer of the capacitor and signal line of the integrated cable.

3. An electromechanical device having a conductive component which is stretchable and having a conductive lead to connect the component to an electrical circuit, wherein the conductive lead is arranged as threaded through the component at multiple locations on the component layer to integrate the lead with the component.

4. The electromechanical device of claim wherein the lead extends through the conductive at multiple locations on the conductive component.

5. The electromechanical device of claim separate wherein the conductive lead is arranged as threaded through the component at multiple locations and along alternate surfaces of the lead so as to cause a load applied by the lead relative to the component to compress the component.

6. The electromechanical device of claim 3 wherein the conductive lead comprises a conductor and an electrically insulating layer and wherein the conductor is exposed to contact the stretchable conductive component.

7. The electromechanical device of claim 3 wherein a set of apertures is formed in the stretchable conductive component and the conductive lead is arranged as threaded through the apertures and wherein the apertures are arranged in a defined pattern to spread over a region the conductive component mechanical stress applied by the conductive lead to the conductive component.

8. The electromechanical device of claim 3 wherein the electromechanical device is a laminated stretchable capacitor and the stretchable conductive component is an electrode layer of the laminated stretchable capacitor.

9. The electromechanical device of claim 8 wherein the conductive lead is arranged threaded over and under the electrode layer.

10. The electromechanical device of claim 3, wherein the electromechanical device comprises a first conductive component and a second conductive component and the conductive lead comprises an inner conductor an outer conductor arranged to cover the inner conductor wherein length of the inner conductor which is exposed is arranged threaded through the first component signal and an exposed length the outer conductor is arranged threaded through second conductive component.

11. The electromechanical device of claim 3, comprising a stress-bearing part of the device, the stress-bearing part connected to the conductive component to receive load from the conductive lead and distribute stress to the conductive component.

12. The electromechanical device of claim 3 wherein the conductive component may be elastic and wherein a conductive lead arranged to be threaded through the conductive component may be retained in firm electrical and mechanical contact with the conductive component by elastic resilience of the conductive component.

13. A process of manufacturing an electro-mechanical device having a conductive component which is stretchable and having a conductive lead to connect the component to an electrical circuit, the process comprising the step of:
arranging the conductive lead so as to be threaded through the conductive component and so as to electrically contact the conductive component to provide a connection for the electrical circuit.

14. The process of claim 13 comprising the step of arranging the conductive lead to extend at multiple locations through the conductive component to spread stress between the multiple locations applied by the lead to the conductive component.
